(19) United States
(12) Patent Application Publication
(10) Pub. No.: US 2021/0270086 A1
(43) Pub. Date: Sep. 2, 2021

(54) Telescopic Ladder

(71) Applicant: Yuejin PAN, Jinhua City (CN)

(72) Inventor: Yuejin PAN, Jinhua City (CN)

(21) Appl. No.: 17/257,288

(22) PCT Filed: Jan. 22, 2017
(86) PCT No.: PCT/CN2017/072012

§ 371 Date: Dec. 30, 2020

(30) Foreign Application Priority Data
Jan. 10, 2017 (CN) 2201710024002.8

(51) Int. Cl. E06C 1/12

(52) U.S. Cl. CPC E06C 1/125

(57) ABSTRACT

A telescopic ladder including two columns, and a plurality of steps, each of which being formed by socketing a smaller tube in a bigger tube, each step being arranged between upper ends of two tubes of a same diameter; an instep-operable folding switch including an operating lever is provided below a first step on the bottom of the ladder; each end of the operating lever contacts a lower end of one transmission bar, an upper end of the transmission bar contacts an end of a pin switch for a second step, and the other end of the pin switch is hinged to a middle portion of a pin with its front end of the pin being fitted in positioning holes of two columns corresponding to the second step, and its rear end of the pin being resisted against a return spring located within a pin connector in the second step.

### TECHNICAL FIELD OF THE INVENTION

The present invention relates to a ladder and in particular to a telescopic ladder.

### BACKGROUND OF THE INVENTION

A telescopic ladder is a necessity for operations at a high level, which can be used when unfolded and stored when folded. Its folding switches are usually arranged at left and right ends of the second step on the bottom of the ladder, one folding switch at each end. A folding switch can be operated only when a user bends down or even squats down. It is likely to result in toppling of the ladder since the user holds the ladder at a too low portion. At best, such toppling may get the ladder damaged; at worst, such toppling may hurt the user or those around the user. Furthermore, a telescopic ladder in the prior art falls quickly when it is folded. There is a risk of having the hands of the user injured if he/she fails to evade in time, when the folding switch is operated by the hands. Therefore, further improvements may be made to the existing telescopic ladders.

### SUMMARY OF THE INVENTION

To overcome the deficiency of the existing telescopic ladders that there is a safety risk when the folding switch is operated by a hand during their use, the present invention provides a telescopic ladder by which the safety risk caused by the operation of the folding switch by a hand can be effectively avoided and the safety can be enhanced.

The present invention employs the following technical solution to solve the above technical problem.

A telescopic ladder, including a left column and a right column, which are symmetrical to each other and arranged longitudinally, and a plurality of steps which are arranged transversely, each of the columns being formed by socketing a smaller tube in a bigger tube, one of the steps being arranged between upper ends of two tubes of a same diameter; an instep-operable folding switch is provided below a first step on the bottom of the ladder; the instep-operable folding switch includes an operating lever on which an operating gasket is fixed; each of two ends of the operating lever comes into contact with a lower end of one transmission bar, an upper end of the transmission bar comes into contact an end of a pin switch for a second step, and the other end of the pin switch is hinged to a middle portion of a pin via a round pin; a front end of the pin is fitted in positioning holes of two columns corresponding to the second step, and a rear end of the pin is resisted against a return spring; and the return spring is located within a pin connector which is fixed within the second step.

Further, the telescopic ladder further includes an anti-misoperation safety mechanism; the anti-misoperation safety mechanism includes a safety block which is fixed on the operating lever; a safety switch is provided outside a step, and a safety box is provided within the step; a slider, a safety spring, a barrier and a torsional spring are provided within the safety box, wherein the safety switch is linked to the slider, one end of the slider is resisted against the safety spring and the other end of the safety spring is fixed within the safety box, and the other end of the slider is fitted with the barrier, the barrier is rotatably mounted on a fulcrum within the safety box, the torsional spring is mounted on the fulcrum, and a hole for inserting the safety block therein is formed on the safety box at a position where the slider is fitted with the barrier; when no unlocking operation is performed, the safety block on the operating lever is resisted against the slider via a hole formed on a bottom surface of a step; and when an unlocking operation is performed, the safety switch drives the slider to operate, the barrier then rotates due to the torsion of the torsional spring to prevent the slider from moving back, and the operating lever drives the safety block to move upward to facilitate the rotation of the barrier.

Still further, the telescopic ladder further includes an anti-misoperation mechanism; the anti-misoperation mechanism includes a support; the operating lever includes a left operating lever connected to the left column and a right operating lever connected to the right column, with an operating gasket being provided on each of the left operating lever and the right operating lever; a right end of the left operating lever is hinged to a lower left end of the support and a left end of the right operating lever is hinged to a lower right end of the support; and an upper portion of the support is fixed on a step.

Still further, the ladder further includes a slow-fall mechanism which is arranged between adjacent column tubes; the slow-fall mechanism includes one upper seal disc arranged within a tube, the upper seal disc being connected to the tube in a sealed manner; a lower seal disc, which is connected to a lower adjacent tube in a sealed manner, is provided within the lower adjacent tube; and an air vent is formed on the lower seal disc.

The air vents include a pore on a bottom surface of the lower seal disc and a gap on a side of the lower seal disc.

A thin slope, which looks like a cone from top to bottom, is formed on a circumference of the upper seal disc, an upper end of the slope has a size equal to or greater than an internal size of a tube, and the upper seal disc is closely fitted to an inner wall of the tube; a limiting step, which is protruded inward, is provided in a radial direction at a lower end of each tube close to its end face; and a thin cylindrical or conical slope is also formed on a circumference of the lower seal disc, the cylindrical or conical slope has a size equal to or greater than an internal size of a lower adjacent bigger tube, and the lower seal disc is closely fitted to an inner wall of the bigger tube.

A connecting disc is provided between the upper seal disc and the lower seal disc; a positioning bar is provided on the upper seal disc, and a positioning through hole for allowing the positioning bar to pass therethrough is formed on the connecting disc; and a positioning blind hole for allowing the positioning bar to insert therein is formed on the lower seal disc.

The concept of the present invention is as follows: for a telescopic ladder having a folding switch which is operated by the instep, since the user can leave his/her hands free to hold the ladder at a higher portion while operating the folding switch by the instep, he/she can hold the ladder stably, and thus the safety risk of resulting in toppling of the ladder since the user holds the ladder at a too low portion when a folding switch can be operated only when the user bends down or even squats down. Further, the present invention provides a slow-fall process which can slow down the falling speed of the ladder when it is folded, so that the safety of the ladder can be further enhanced.

The present invention has the beneficial effects that the safety risk caused by the operation of the folding switch by a hand can be effectively avoided and the safety can be enhanced.

### BRIEF DESCRIPTION OF THE DRAWINGS

FIG. 1 is a view showing the appearance of a telescopic ladder, when in the folded state (a) and in the unfolded state (b), respectively;

FIG. 2 is a sectional view showing the structure of an instep-operable folding switch;

FIG. 3 is a sectional view showing the structure of an instep-operable folding switch which is derived from that shown in FIG. 2, additionally provided with an anti-misoperation safety mechanism;

FIG. 4 is a partially enlarged view of FIG. 3, (a): in the locked stated, (b): in the unlocked stated, and (c): in the folded state of the ladder;

FIG. 5 is a view showing the structure of an instep-operable folding switch which is derived from that shown in FIG. 2, having an anti-misoperation design;

FIG. 6 is an exploded view of the structure of a slow-fall mechanism;

FIG. 7 is a sectional view of the structure of the slow-fall mechanism during the folding process; and

FIG. 8 is a partially enlarged view of part A of FIG. 7.

### DETAILED DESCRIPTION OF THE INVENTION

The present invention will be further described below with reference to the accompanying drawings.

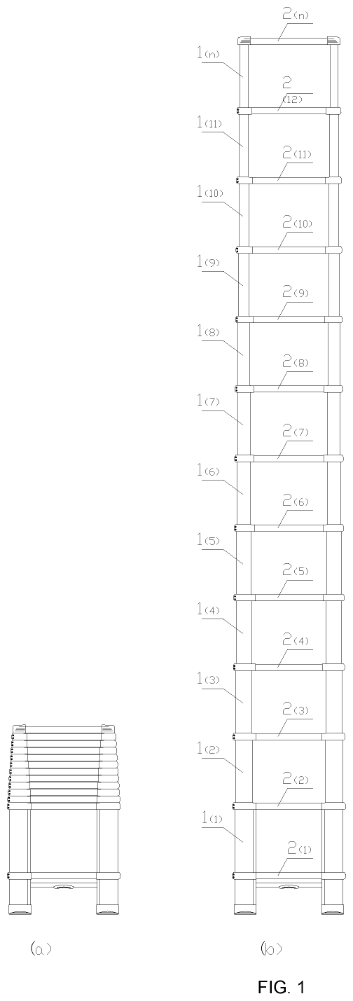

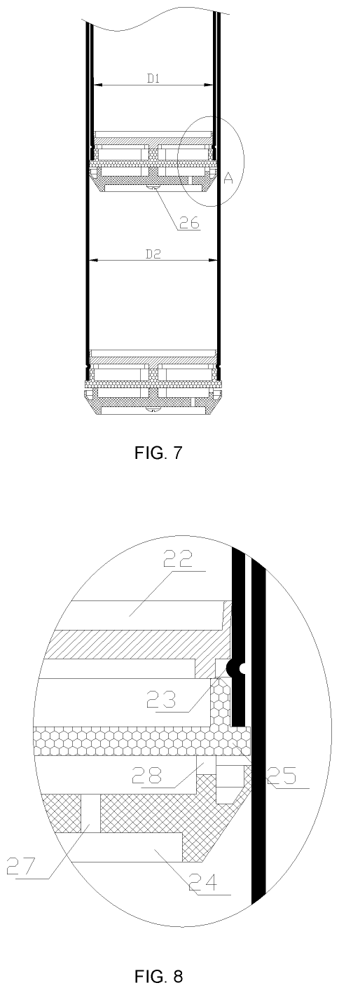

Referring to FIGS. 1-8, a telescopic ladder, including a left column and a right column, which are symmetrical to each other and arranged longitudinally, and a plurality of steps which are arranged transversely, each of the columns being formed by socketing a smaller tube in a bigger tube, one of the steps being arranged between upper ends of two tubes of a same diameter; an instep-operable folding switch is provided below a first step on the bottom of the ladder; the instep-operable folding switch includes an operating lever on which an operating gasket is fixed; each of two ends of the operating lever comes into contact with a lower end of one transmission bar, an upper end of the transmission bar comes into contact an end of a pin switch for a second step, and the other end of the pin switch is hinged to a middle portion of a pin via a round pin; a front end of the pin is fitted in positioning holes of two columns corresponding to the second step, and a rear end of the pin is resisted against a return spring; and the return spring is located within a pin connector which is fixed within the second step.

Further, the telescopic ladder further includes an anti-misoperation safety mechanism; the anti-misoperation safety mechanism includes a safety block which is fixed on the operating lever; a safety switch is provided outside a step, and a safety box is provided within the step; a slider, a safety spring, a barrier and a torsional spring are provided within the safety box, wherein the safety switch is linked to the slider, one end of the slider is resisted against the safety spring and the other end of the safety spring is fixed within the safety box, and the other end of the slider is fitted with the barrier, the barrier is rotatably mounted on a fulcrum within the safety box, the torsional spring is mounted on the fulcrum, and a hole for inserting the safety block therein is formed on the safety box at a position where the slider is fitted with the barrier; when no unlocking operation is performed, the safety block on the operating lever is resisted against the slider via a hole formed on a bottom surface of a step; and when an unlocking operation is performed, the safety switch drives the slider to operate, the barrier then rotates due to the torsion of the torsional spring to prevent the slider from moving back, and the operating lever drives the safety block to move upward to facilitate the rotation of the barrier.

Still further, the telescopic ladder further includes an anti-misoperation mechanism; the anti-misoperation mechanism includes a support; the operating lever includes a left operating lever connected to the left column and a right operating lever connected to the right column, with an operating gasket being provided on each of the left operating lever and the right operating lever; a right end of the left operating lever is hinged to a lower left end of the support and a left end of the right operating lever is hinged to a lower right end of the support; and an upper portion of the support is fixed on a step.

Still further, the ladder further includes a slow-fall mechanism which is arranged between adjacent column tubes; the slow-fall mechanism includes one upper seal disc arranged within a tube, the upper seal disc being connected to the tube in a sealed manner; a lower seal disc, which is connected to a lower adjacent tube in a sealed manner, is provided within the lower adjacent tube; and an air vent is formed on the lower seal disc.

The telescopic ladder of this embodiment, the basic appearance of which in the folded state and the unfolded state is shown in FIG. 1, includes a left column 1 and a right column 1, which are symmetrical to each other and arranged longitudinally, and a plurality of steps 2 which are arranged transversely; and each of the columns 1 is formed by socketing a smaller tube in a bigger tube 1(1) . . . 1(n). This is the conventional structure of a telescopic ladder.

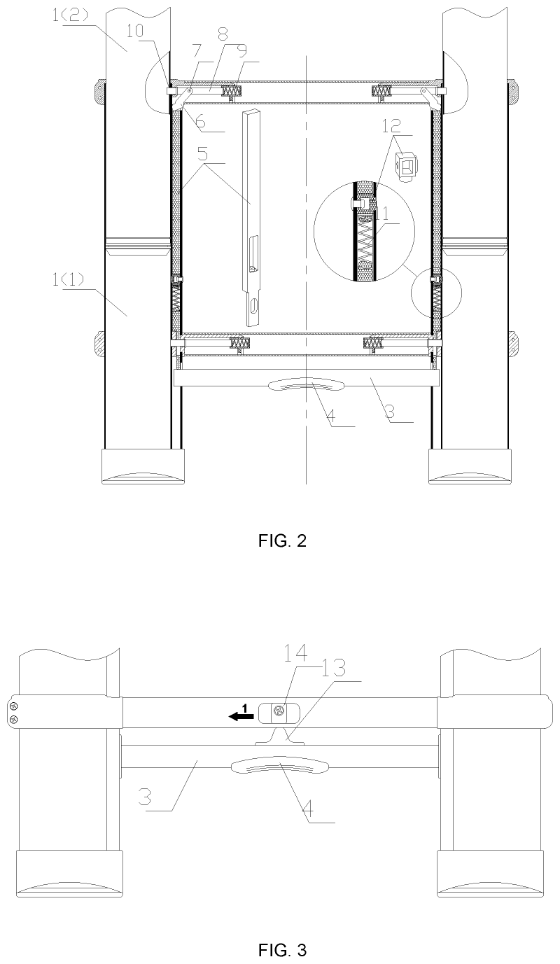

Referring to FIG. 2 which is a sectional view showing the structure of an instep-operable folding switch according to the embodiment of the present invention, the instep-operable folding switch includes an operating lever 3 arranged below a step 2(1) on the bottom of the ladder; an operating gasket 4 is fixed in the middle portion of the operating lever 3; and two ends of the operating lever 3 come into contact with a lower end of a transmission bar 5 arranged within a column 1(1), an upper end of the transmission bar 5 comes into contact with a lower end of a pin switch 6 for a second step 2(2), a lower end of the pin switch 6 also comes into contact with an outer surface of the column 1(1), and an upper end of the pin switch 6 is hinged to a pin 8 via a round pin 7. When the operating gasket 4 is lifted up by the instep of a user, the operating lever 3 drives the transmission bar 5 to move upward, the upper end of the transmission bar 5 is resisted against the pin switch 6 for the second step 2(2), the pin 8 hinged to the pin switch 6 moves toward an end where a spring 9 is provided and then exits from a positioning hole 10 on the column 1(2), and the step 2(3) and the associated column 1(2) are subsequently folded and fall down. When all those actions are completed and the action of lifting the operating gasket 4 up by the instep is released, since a spring 11 is provided within the transmission bar 5 with one end of the spring 11 being resisted against the transmission bar 5 while the other end thereof being resisted against a spring holder 12 for the column 1(2), the transmission bar 5 enables the operating lever 3 to fall down and return to its original position due to the press force from the spring 11. In this way, one operation of folding the telescopic ladder is completed.

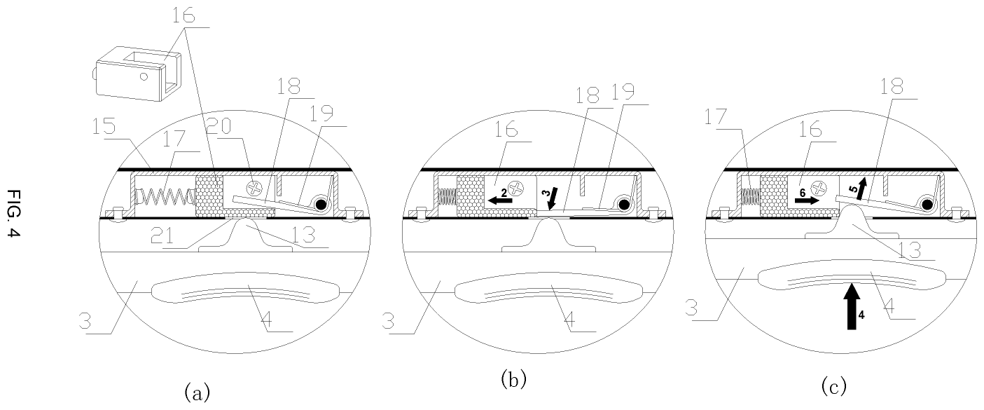

Referring to FIG. 3 and FIG. 4 which are sectional views showing the structure of an instep-operable folding switch which is derived from that shown in FIG. 2, additionally provided with an anti-misoperation safety mechanism, the specific implementation is as follows: a safety block 13 is fixed on the operating lever 3, a safety switch 14 is additionally provided outside the step 2(1), and a fixed safety box 15 is provided within the step 2(1); a slider 16, a spring 17, a barrier 18 and a torsional spring 19 are provided within the safety box 15, wherein the safety switch 14 is linked to the slider 16 via screws 20. Referring to FIG. 4(a), in the locked state, the safety block 13 on the operating lever 3 is resisted against the slider 16 via a hole 21 formed on a bottom surface of a step, and in this case, the operating lever 3 is unable to move upward. Referring to FIG. 4(b), when the ladder is rested against a wall after use, the safety switch 14 is pulled in a direction indicated by Arrow 1, this drives the slider 16 to move in a direction indicated by Arrow 2, and the barrier 18 then rotates in a direction indicated by Arrow 3 due to the torsion of the torsional spring 19 to prevent the slider 16 from moving back. In this case, without the obstruction of the slider 16, the operating lever 3 can move upward. Referring to FIG. 4(c), in this case, the operating lever 3 is operated by the instep to move in a direction indicated by Arrow 4. Then, the ladder is folded, as shown in FIG. 2. Meanwhile, the safety block 13 fixed on the operating lever 3 drives the barrier 18 to rotate in a direction indicated by Arrow 5. In this case, without the obstruction of the barrier 18, the slider 16 moves quickly in a direction indicated by Arrow 6 under the effect of the spring 17. The telescopic ladder returns to the state as shown in FIG. 4(a). That is, one operation of folding the ladder is completed.

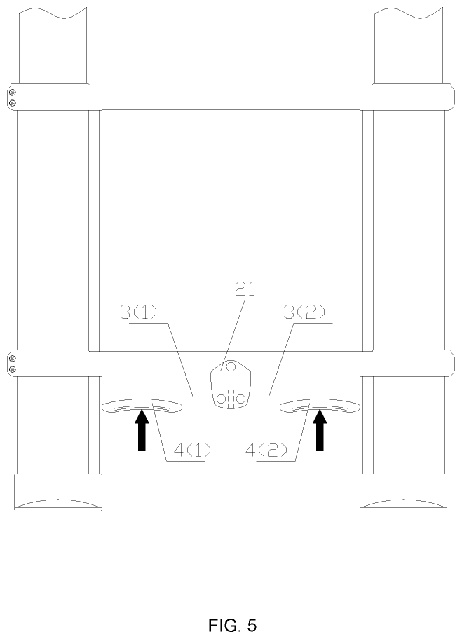

Referring to FIG. 5 which is a view showing the structure of an instep-operable folding switch which is derived from that shown in FIG. 2, having an anti-misoperation design, the specific implementation is as follows: the operating lever 3 as shown in FIG. 2 is divided into two operating levers, i.e., an operating lever 3(1) and an operating lever 3(2); a support 21 is fixed on the step 2(1); an end of each of the operating lever 3(1) and the operating lever 3(2) close to the middle line of the ladder is mounted on the support 21, and is rotary; and an operating gasket 4(1) and an operating gasket 4(2) are separately fixed at an end of each of the operating lever 3(1) and the operating lever 3(2) close to the column 1. When it is needed to fold the ladder, each of the operating gasket 4(1) and the operating gasket 4(2) is lifted up by the instep once, and then one operation of folding the ladder is completed.

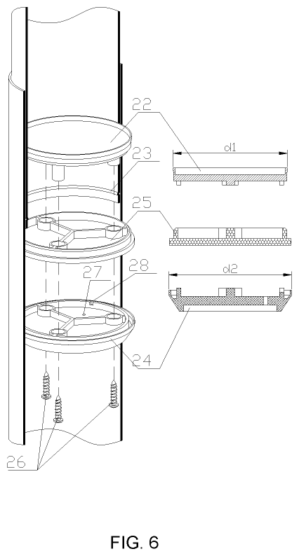

Referring to FIGS. 6-8 which are sectional views of a slow-fall mechanism according to the embodiment of the present invention, a slow-fall mechanism is mounted at a bottom end of each of tubes 1(2) . . . 1(n) which are socketed one within another to form the column. The slow-fall mechanism includes one upper seal disc 22 arranged within a lower portion of a tube. A thin slope, which looks like a cone from top to bottom, is formed on a circumference of the upper seal disc 22, an upper end of the slope has a size d1 equal to or slightly greater than an internal size D1 of the tube, and the upper seal disc 22 can be closely fitted to an inner wall of the tube. A limiting step 23, which is protruded inward, is provided in a radial direction at a lower end of the tube close to its end face. The upper seal disc 22 is assembled from the upper end of the tube, until the lower end of the upper seal disc 22 is resisted against the limiting step 23. A lower seal disc 24 is provided outside the tube. A thin cylindrical or conical slope is also formed on a circumference of the lower seal disc 24, the cylindrical or conical slope has a size d2 equal to or slightly greater than an internal size D2 of a bigger one of adjacent tubes, and the lower seal disc 24 can be closely fitted to an inner wall of the bigger tube. A connecting disc 25 is provided between the upper seal disc 22 and the lower seal disc 24. The lower seal disc 24, the connecting disc 25 and the upper seal disc 22 are connected together and fixed at the lower end of each tube by screws 26. Since the upper seal disc 22 is closely fitted to the inner wall of a smaller one of adjacent tubes and the lower seal disc is closely fitted to the inner wall of a bigger one of adjacent tubes, when the ladder is folded and falls down, air between the two tubes is expelled from a pore 27 and a gap 28 on the lower seal disc. Then, the ladder slowly falls down.

1. A telescopic ladder, comprising a left column and a right column which are symmetrical to each other and arranged longitudinally, and a plurality of steps which are arranged transversely, each of the columns being formed by socketing a smaller tube in a bigger tube, one of the steps being arranged between upper ends of two tubes of a same diameter, wherein an instep-operable folding switch is provided below a first step on the bottom of the ladder; the instep-operable folding switch comprises an operating lever on which an operating gasket is fixed; each of two ends of the operating lever comes into contact with a lower end of one transmission bar, an upper end of the transmission bar comes into contact an end of a pin switch for a second step, and the other end of the pin switch is hinged to a middle portion of a pin via a round pin; a front end of the pin is fitted in positioning holes of two columns corresponding to the second step, and a rear end of the pin is resisted against a return spring; and the return spring is located within a pin connector which is fixed within the second step; the ladder further comprises a slow-fall mechanism which is arranged between adjacent column tubes; the slow-fall mechanism comprises one upper seal disc arranged within a tube, the upper seal disc being connected to the tube in a sealed manner; a lower seal disc, which is connected to a lower adjacent tube in a sealed manner, is provided within the lower adjacent tube; and air vents are formed on the lower seal disc.

2. The telescopic ladder according to claim 1, wherein the telescopic ladder further comprises an anti-misoperation safety mechanism; the anti-misoperation safety mechanism comprises a safety block which is fixed on the operating lever; a safety switch is provided outside a step, and a safety box is provided within the step; a slider, a safety spring, a barrier and a torsional spring are provided within the safety box, wherein the safety switch is linked to the slider, one end of the slider is resisted against the safety spring and the other end of the safety spring is fixed within the safety box, and the other end of the slider is fitted with the barrier, the barrier is rotatably mounted on a fulcrum within the safety box, the torsional spring is mounted on the fulcrum, and a hole for inserting the safety block therein is formed on the safety box at a position where the slider is fitted with the barrier; when no unlocking operation is performed, the safety block on the operating lever is resisted against the slider via a hole formed on a bottom surface of a step; and when an unlocking operation is performed, the safety switch drives the slider to operate, the barrier then rotates due to the torsion of the torsional spring to prevent the slider from moving back, and the operating lever drives the safety block to move upward to facilitate the rotation of the barrier.

3. The telescopic ladder according to claim 1, wherein the telescopic ladder further comprises an anti-misoperation mechanism; the anti-misoperation mechanism comprises a support; the operating lever comprises a left operating lever connected to the left column and a right operating lever connected to the right column, with an operating gasket being provided on each of the left operating lever and the right operating lever; a right end of the left operating lever is hinged to a lower left end of the support and a left end of the right operating lever is hinged to a lower right end of the support; and an upper portion of the support is fixed on a step.

4. The telescopic ladder according to claim 1, wherein the air vents comprise a pore on a bottom surface of the lower seal disc and a gap on a side of the lower seal disc.

5. The telescopic ladder according to claim 1, wherein a thin slope, which looks like a cone from top to bottom, is formed on a circumference of the upper seal disc, with an upper end of the slope having a size equal to or greater than an internal size of a tube, and the upper seal disc being closely fitted to an inner wall of the tube; a limiting step, which is protruded inward, is provided in a radial direction at a lower end of each tube close to its end face; and a thin cylindrical or conical slope is also formed on a circumference of the lower seal disc, with the cylindrical or conical slope having a size equal to or greater than an internal size of a lower adjacent bigger tube, and the lower seal disc being closely fitted to an inner wall of the bigger tube.

6. The telescopic ladder according to claim 1, wherein a connecting disc is provided between the upper seal disc and the lower seal disc; a positioning bar is provided on the upper seal disc, and a positioning through hole for allowing the positioning bar to pass therethrough is formed on the connecting disc; and a positioning blind hole for allowing the positioning bar to insert therein is formed on the lower seal disc.

7. The telescopic ladder according to claim 2, wherein the air vents comprise a pore on a bottom surface of the lower seal disc and a gap on a side of the lower seal disc.

8. The telescopic ladder according to claim 3, wherein the air vents comprise a pore on a bottom surface of the lower seal disc and a gap on a side of the lower seal disc.

9. The telescopic ladder according to claim 2, wherein a thin slope, which looks like a cone from top to bottom, is formed on a circumference of the upper seal disc, with an upper end of the slope having a size equal to or greater than an internal size of a tube, and the upper seal disc being closely fitted to an inner wall of the tube; a limiting step, which is protruded inward, is provided in a radial direction at a lower end of each tube close to its end face; and a thin cylindrical or conical slope is also formed on a circumference of the lower seal disc, with the cylindrical or conical slope having a size equal to or greater than an internal size of a lower adjacent bigger tube, and the lower seal disc being closely fitted to an inner wall of the bigger tube.

10. The telescopic ladder according to claim 3, wherein a thin slope, which looks like a cone from top to bottom, is formed on a circumference of the upper seal disc, with an upper end of the slope having a size equal to or greater than an internal size of a tube, and the upper seal disc being closely fitted to an inner wall of the tube; a limiting step, which is protruded inward, is provided in a radial direction at a lower end of each tube close to its end face; and a thin cylindrical or conical slope is also formed on a circumference of the lower seal disc, with the cylindrical or conical slope having a size equal to or greater than an internal size of a lower adjacent bigger tube, and the lower seal disc being closely fitted to an inner wall of the bigger tube.

11. The telescopic ladder according to claim 2, wherein a connecting disc is provided between the upper seal disc and the lower seal disc; a positioning bar is provided on the upper seal disc, and a positioning through hole for allowing the positioning bar to pass therethrough is formed on the connecting disc; and a positioning blind hole for allowing the positioning bar to insert therein is formed on the lower seal disc.

12. The telescopic ladder according to claim 3, wherein a connecting disc is provided between the upper seal disc and the lower seal disc; a positioning bar is provided on the upper seal disc, and a positioning through hole for allowing the positioning bar to pass therethrough is formed on the connecting disc; and a positioning blind hole for allowing the positioning bar to insert therein is formed on the lower seal disc.
